(19) United States
(12) Patent Application Publication
(10) Pub. No.: US 2004/0068466 A1
(43) Pub. Date: Apr. 8, 2004

(54) Method for providing for the purchase of cellular telephone service

(76) Inventor: Tod S. Ryan, Folsom, CA (US)

Correspondence Address: Audrey A. Millemann, Weintraub Genshlea Chediak Sproul, 11th Floor, 400 Capitol Mall, Sacramento, CA, 95814, US

(21) Appl. No.: 10/678,401

(22) Filed: Oct. 3, 2003

Related U.S. Application Data
(60) Provisional application No. 60/416,721, filed on Oct. 8, 2002.

(51) Int. Cl. G06F 17/60

(52) U.S. Cl. 705/38; 705/40

(57) ABSTRACT

The invention is a method of providing a prospective purchaser with the opportunity to purchase cellular telephone service in an automated, real-time fashion.

### CROSS-REFERENCE TO RELATED APPLICATION

The present application claims the benefit of U.S. provisional application No. 60/416,721, filed Oct. 8, 2002 and entitled “Real-Time Self-Serve Wireless Phone Provisioning”, which is hereby incorporated by reference.

### BACKGROUND OF THE INVENTION

1. Field of the Invention

The invention relates to methods of providing prospective purchasers with the opportunity to purchase cellular telephone service.

2. Description of Related Art

There are three existing methods for purchasing cellular telephone services (and possibly also a cellular telephone): retail, telesales, and the internet. In the retail method, the perspective purchaser visits a retail store, typically either operated by a cellular telephone carrier or by an independent dealer or agent. The customer obtains information from a sales clerk, and manually fills out a contract. When the contract has been filled out, the sales clerk transcribes the relevant information into a front end system, obtains a credit approval, and completes the transaction by activating the telephone from the store's inventory.

The telesales method is very similar to the retail method except that it is handled over the telephone. The customer telephones a call center, obtains information from a sales representative, and then orders the service from the sales representative. The sales representative obtains the customer's information and transfers the relevant information into a front end system, obtains a credit approval, and completes the order. The telephone is obtained from a warehouse, activated, and shipped to the customer.

The internet method typically utilizes the website of the cellular telephone carrier or its agent. The sales process is similar to that of most e-commerce transactions. The customer fills out an application on line and the information is transmitted to the cellular telephone service provider. The telephone service is then activated.

All three of the existing methods suffer from the problem that they are not as quick for the customer and that the telephone service is not established in an automated and real-time fashion.

### SUMMARY OF THE INVENTION

The present invention is directed to a method for providing a person the opportunity to purchase cellular telephone services in an automated, real-time fashion. The method is quicker for the purchaser than existing methods, is consistent and accurate, and provides the prospective purchaser with a pleasant sales experience. The method also provides the telephone service carrier with increased sales opportunities without further increasing the demand on existing resources. In addition, the method can be easily accessed by prospective purchasers.

The invention is a method for providing an opportunity for a person to purchase cellular telephone service. The method comprises providing information on cellular telephone service to a prospective purchaser of cellular telephone service; receiving information from the prospective purchaser of cellular telephone service pertaining to the purchase of cellular telephone service, which may include information necessary for a credit check of the purchaser; transmitting the purchase information to a provider of cellular telephone service, which may be directly to a carrier's billing system; providing the prospective purchaser with confirmation that the provider of cellular telephone services received the purchase information, which may include a credit approval; receiving authorization to activate cellular telephone service for the person; and transmitting the authorization to the provider of cellular telephone service.

### BRIEF DESCRIPTION OF THE DRAWINGS

FIG. 1 is a diagram showing the flow of information in the method of the invention.

### DETAILED DESCRIPTION OF THE PREFERRED EMBODIMENTS

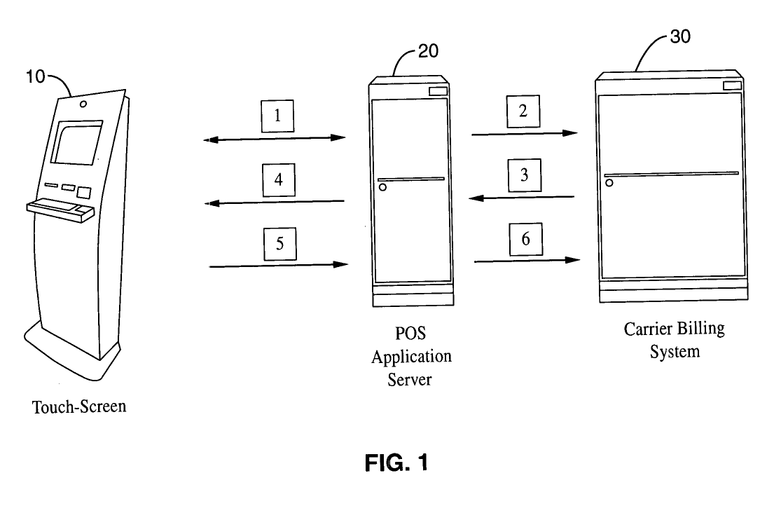

The description is in reference to FIG. 1. FIG. 1 shows touch-screen 10, point of sale (“POS”) application server 20, and carrier billing system 30. Carrier billing system 30 is the billing system of a provider of cellular telephone service.

In step 1, information about cellular telephone services and possibly also on cellular telephones, is provided to a prospective purchaser by POS application server 20.

The prospective purchaser communicates with POS application server 20 by using self-serve touch-screen computer 10, which may be located in a kiosk. After the prospective purchaser decides on the desired service, POS application server 20 asks for certain personal information necessary to set up service, which may include information necessary to check their credit. POS application server 20 then receives the prospective purchaser's information.

In step 2, POS application server 20 transmits the prospective purchaser's information to a provider or carrier of cellular telephone service, which may be sent directly to carrier billing system 30.

In step 3, POS application server 20 receives information back from the provider, which may be directly from carrier billing system 30. This information may include a credit approval.

In step 4, that information is transmitted by POS application server 20 to the prospective purchaser.

In step 5, POS application server 20 receives authorization to activate the cellular telephone service.

In step 6, this authorization is transmitted to the provider or carrier billing system 30, such that service can be activated.

I claim:

1. A method of providing an opportunity for a person to purchase cellular telephone service, comprising:
providing information about cellular telephone service to a person, wherein said person is a prospective purchaser of cellular telephone service;
receiving information from said person pertaining to the purchase of said cellular telephone service;
transmitting said purchase information to a provider of cellular telephone service;
providing said person with information from said provider of cellular telephone service;
receiving authorization to activate cellular telephone service for said person; and
transmitting said authorization to said provider of cellular telephone service.

2. The method of claim 1, further comprising, wherein said transmitting of said purchase information is to said cellular telephone service provider's billing system.

3. The method of claim 1, wherein said transmitting of said authorization to said cellular telephone service provider is to said cellular telephone service provider's billing system.

4. The method of claim 1, wherein said purchase information includes information necessary to perform a credit check.

5. The method of claim 1, wherein said information from said provider of cellular telephone service includes a credit approval.
